(19) United States
(12) Patent Application Publication
(10) Pub. No.: US 2012/0216529 A1
(43) Pub. Date: Aug. 30, 2012

(54) ENGINE EXHAUST AFTERTREATMENT SYSTEM

(75) Inventors: Alok A. Joshi, Columbus, IN (US); Sriram S. Popuri, Greenwood (IN); Timothy R. Frazier, Columbus, IN (US); Neal W. Currier, Columbus, IN (US); Aleksey Yezerets, Columbus, IN (US)

(73) Assignee: Cummins Intellectual Property, Inc., Minneapolis, MN (US)

(21) Appl. No.: 13/407,675

(22) Filed: Feb. 28, 2012

Related U.S. Application Data
(60) Provisional application No. 61/447,542, filed on Feb. 28, 2011.

(51) Int. Cl. F01N 3/20; F02D 23/00; F02B 33/40

(52) U.S. Cl. 60/602; 60/612

(57) ABSTRACT

An internal combustion engine including a two-stage turbocharger configuration is described. Located between the turbines of the two-stage turbocharger may be an oxidation catalyst and a passive NOx adsorber or an oxidation catalyst and an SCR device. An exhaust path extending from an engine body of the internal combustion engine to the second turbine of the two-stage turbocharger configuration may also include one or more hydrocarbon sources or one or more ammonia sources. A bypass valve arrangement may permit decreased flow through the first stage of the two-stage turbocharger arrangement as well as one or more of the elements positioned between the turbines of the two-stage turbocharger.

### CROSS-REFERENCE TO RELATED APPLICATIONS

This application claims the benefit of priority to U.S. Provisional Patent Application No. 61/447,542, filed on Feb. 28, 2010, which is hereby incorporated by reference in its entirety.

### TECHNICAL FIELD

This disclosure relates to a system for the treatment of NOx in internal combustion engines during cold start operation.

### BACKGROUND

During cold start of an internal combustion engine, for example an engine that may be within a light-duty chassis-certified vehicle, the temperature in a selective catalytic reduction (SCR) device may be insufficient to initiate NOx conversion. The temperature of engine exhaust gases and mass flow entering an aftertreatment system may also be insufficient to raise the temperature of the SCR device for immediate NOx conversion, which results in relatively high and undesirable NOx emissions from the exhaust tailpipe, stack or other atmospheric venting location. Improving cold start performance of internal combustion engines would decrease undesirable NOx emissions during cold start and may indirectly improve fuel efficiency.

### SUMMARY

This disclosure provides an internal combustion engine comprising an engine body, an aftertreatment system, an exhaust flow path, a high-pressure turbine, a low-pressure turbine, an oxidation catalyst, and a selective catalytic reduction device. The exhaust flow path extends from the engine body to the aftertreatment system. The high-pressure turbine is positioned along the exhaust flow path between the engine body and the aftertreatment system. The low-pressure turbine is positioned along the exhaust flow path between the high-pressure turbine and the aftertreatment system. The oxidation catalyst is positioned along the exhaust flow path between the high-pressure turbine and the low-pressure turbine. The selective catalytic reduction device is positioned along the exhaust flow path between the oxidation catalyst and the low-pressure turbine.

This disclosure also provides an internal combustion engine comprising an engine body, an aftertreatment system, an exhaust flow path, a high-pressure turbine, a low-pressure turbine, an oxidation catalyst, and a selective catalytic reduction device. The exhaust flow path extends from the engine body to the aftertreatment system. The high-pressure turbine is positioned along the exhaust flow path between the engine body and the aftertreatment system. The low-pressure turbine is positioned along the exhaust flow path between the high-pressure turbine and the aftertreatment system. The oxidation catalyst is positioned along the exhaust flow path between the high-pressure turbine and the low-pressure turbine. The passive NOx adsorber is positioned along the exhaust flow path between the oxidation catalyst and the low-pressure turbine.

This disclosure also provides a method of controlling emissions from an internal combustion engine during cold start operation. The method comprises providing an exhaust gas flow path from an internal combustion engine through a first turbine, a second turbine, and a downstream aftertreatment system having a first operating temperature. The method further comprises positioning at least one emission reducing device, having a second operating temperature lower than the first operating temperature, between the first turbine and the second turbine, the at least one emission reducing device operable to react a fluid with emissions from the internal combustion engine to reduce the volume of the emissions. The method also comprises providing the fluid to the exhaust gas flow path between the internal combustion engine and the at least one emission reducing device. The method includes providing a bypass path from the internal combustion engine to the exhaust gas flow path at a location between the second turbine and the at least one emission reducing device and engaging the bypass path when the temperature in the exhaust gas flow path reaches the first operating temperature.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic of a first conventional internal combustion engine configuration.

FIG. 2 is a schematic of a second conventional internal combustion engine configuration.

FIG. 3 is a schematic of a first exemplary embodiment of the present disclosure.

FIG. 4 is a schematic of a second exemplary embodiment of the present disclosure.

### DETAILED DESCRIPTION

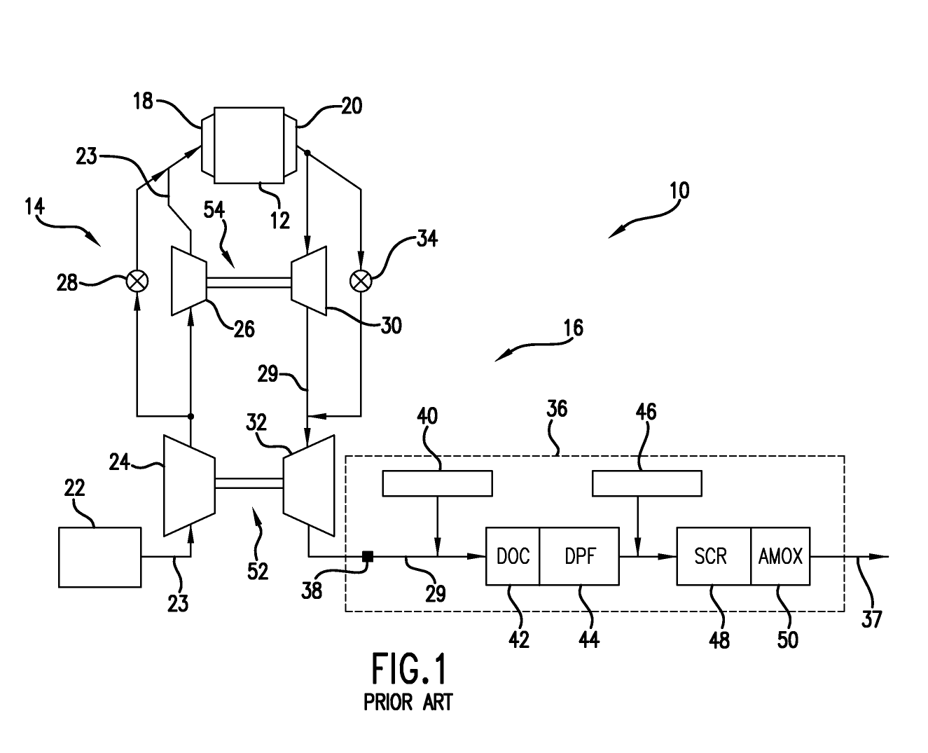

Referring now to FIG. 1, a conventional internal combustion engine 10 includes an engine body or block 12, an intake system 14, and an exhaust system 16. Engine body 12 includes an intake manifold 18 and an exhaust manifold 20.

Intake system 14 may include an air source 22, a low-pressure compressor 24, a high-pressure compressor 26, and a high-pressure compressor (HPC) bypass valve 28. Low-pressure compressor 24 is positioned along an intake flow path 23 that extends downstream from air source 22 to intake manifold 18. High-pressure compressor 26 is positioned along intake flow path 23 between low-pressure compressor 24 and intake manifold 18. HPC bypass valve 28 may be positioned in a bypass path connected at one end at a location between low-pressure compressor 24 and high-pressure compressor 26 and at an opposite end to intake flow path 23 downstream of high-pressure compressor 26, thus providing a path around high-pressure compressor 26.

Exhaust system 16 may include a high-pressure turbine 30, a low-pressure turbine 32, a high-pressure turbine (HPT) bypass valve 34, an aftertreatment system 36, and a tailpipe, stack, or atmospheric vent 37. Aftertreatment system 36 may include a NOx and temperature sensor 38; a hydrocarbon source 40; an oxidation catalyst 42, which may be a diesel oxidation catalyst; a particulate filter 44, which may be a diesel particulate filter, an ammonia source 46; a selective catalytic reduction device (SCR) 48; and an ammonia oxidation catalyst 50.

The various elements of exhaust system 16 may be positioned along an exhaust flow path 29, which extends downstream from exhaust manifold 20 to atmospheric vent 37, which may be a tailpipe, stack or other device that performs a similar function. Low-pressure turbine 32 may be positioned along exhaust flow path 29 between exhaust manifold 20 and tailpipe 37. High-pressure turbine 30 may be located along exhaust flow path 29 between exhaust manifold 20 and low-pressure turbine 32. HPT bypass valve 34 may be positioned in a bypass path extending from upstream of high-pressure turbine 30 to a location along exhaust flow path 29 upstream of low-pressure turbine 32 and downstream of high-pressure turbine 30. Aftertreatment system 36 may be located along exhaust flow path 29 between low-pressure turbine 32 and tailpipe or stack 37.

Within aftertreatment system 36, oxidation catalyst 42, particulate filter 44, SCR device 48, and ammonia oxidation catalyst 50 are positioned along exhaust flow path 29. SCR device 48 and ammonia oxidation catalyst 50 may be combined as a single zone-coated substrate or may be two separate substrates. Hydrocarbon source 40 connects to exhaust flow path 29 at a location downstream of low-pressure turbine 32 and upstream from oxidation catalyst 42. Hydrocarbon source 40 may include a supply of pressurized hydrocarbon fluid, such as fuel, and a flow control valve (not shown) to control the amount of fuel delivered to exhaust flow path 29. Hydrocarbon source 40 may be an engine-managed late post injection, an external hydrocarbon doser, or a synthesis gas generator. The hydrocarbon fluid reacts with carbon monoxide from engine 10 in oxidation catalyst 42 to form carbon dioxide and water. By controlling the amount of hydrocarbon fluid delivered into exhaust flow path 29, the amount of carbon monoxide emitted from atmospheric vent 37 can be effectively controlled. Ammonia source 46 may connect to exhaust flow path 29 at a location downstream from particulate filter 44. Ammonia source 46 may be a urea doser or a gaseous NH3 generator and may include a flow control valve to vary the amount of fluid supplied by ammonia source 46 into exhaust flow path 29. The fluid provided by ammonia source 46 reacts with NOx from engine 10 to form nitrogen and water. By controlling the amount of fluid supplied by ammonia source 46, NOx emitted from atmospheric vent 37 can be effectively controlled.

Air flows from intake source 22 downstream into low-pressure compressor 24, which is part of a low-pressure turbocharger 52 and which is driven by turbine 32 of low-pressure turbocharger 52. The action of low-pressure compressor 24 forces air downstream to high-pressure compressor 26, which is part of a high-pressure turbocharger 54 and which is driven by high-pressure turbine 30. Low-pressure turbocharger 52 and high-pressure turbocharger 54 thus form a two-stage turbocharger configuration. HPC bypass valve 28 is in a position to provide all airflow from low-pressure compressor 24 to high-pressure compressor 26, meaning that the bypass path is closed. In the event high-pressure compressor 26 is incapable of compressing intake air, perhaps because exhaust flow is too high, if engine 10 requires less pressure from high-pressure compressor 26, or for other operational reasons, HPC bypass valve 28 may direct some or all airflow from low-pressure compressor 24 directly to intake manifold 18.

After combustion in engine body 12, exhaust gases exit engine body 12 by way of exhaust manifold 20, entering exhaust flow path 29 of exhaust system 16. The exhaust gas may flow downstream to high-pressure turbine 30, causing rotation of high-pressure turbine 30, which then drives high-pressure compressor 26, previously described. Exhaust gas then flows to low-pressure turbine 32, causing rotation of low-pressure turbine 32, which drives low-pressure compressor 24, previously described. The exhaust gas follows this flow path because HPT bypass valve 34 is normally closed, blocking exhaust gas flow through the bypass path. If exhaust flow is too high to drive high-pressure turbine 30 or if there are other reasons to bypass high-pressure turbine 30, HPT bypass valve 34 may direct some or all exhaust gas flow around high-pressure turbine 30 directly to low-pressure turbine 32. Flowing downstream from low-pressure turbine 32, the exhaust gas enters aftertreatment system 36. Signals from temperature and pressure sensor 38 provide information to engine 10 that assists engine 10 in determining the timing and amount of hydrocarbons that hydrocarbon source 40 should introduce into exhaust flow path 29 and the timing and amount that ammonia source 46 should introduce into exhaust flow path 29. Engine 10 may use information from other sensors and systems (not shown) to assist in the determination of when and how much hydrocarbons and ammonia need to be introduced into flow path 29. Exhaust gas flows into oxidation catalyst 42, which converts hydrocarbons from hydrocarbon source 40 and carbon monoxide from engine 10 into water and carbon dioxide. The exhaust gas then enters particulate filter 44, which removes soot and other particulates from the exhaust gas flow. As the exhaust gas flows toward SCR 48, ammonia may be introduced into exhaust gas flow path 29 by ammonia source 46. SCR 48 uses the ammonia to convert NOx into nitrogen and water. Because of the possibility of ammonia slip into the exhaust gas flow or stream, ammonia oxidation catalyst 50 may be located downstream from SCR 48. Catalyst 50 acts to convert ammonia to nitrogen and water. The exhaust gas may then flow to an atmospheric outlet or vent 37, which may be a tailpipe, stack or other device.

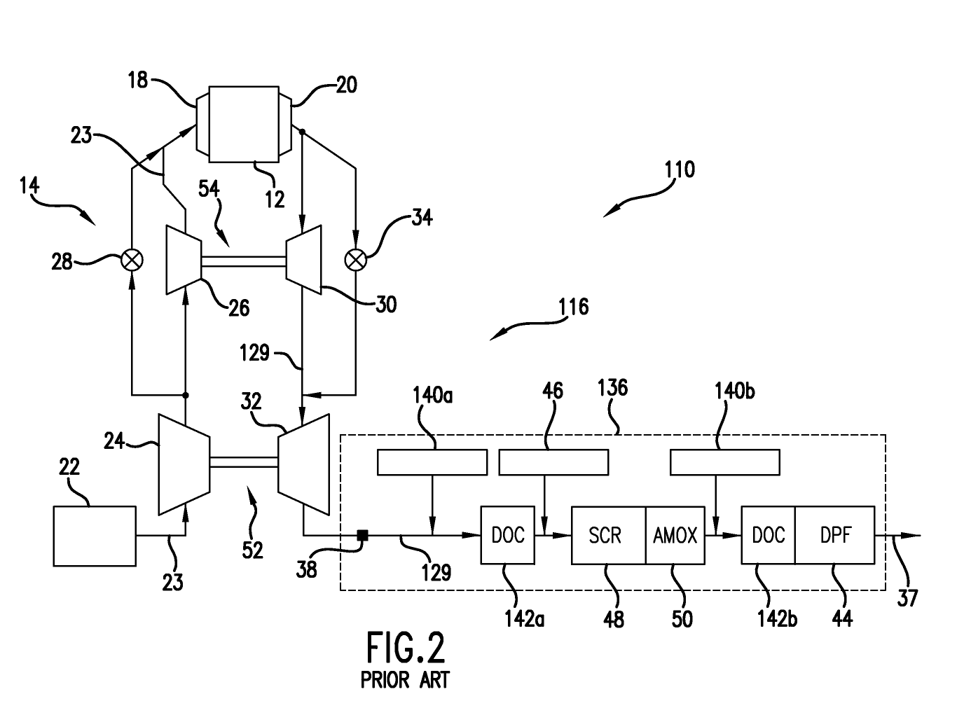

Referring now to FIG. 2, a conventional internal combustion engine 110 includes engine body or block 12, intake system 14, and an exhaust system 116. Engine 110 shares many features with internal combustion engine 10. Because these features work as described with respect to engine 10 in FIG. 1, features having the same number in FIG. 2 are described again only for the benefit of clarity to the description of engine 110 in FIG. 2.

Intake system 14 is as described in the previous figure. Exhaust system 116 may include high-pressure turbine 30, low-pressure turbine 32, high-pressure turbine (HPT) bypass valve 34, an aftertreatment system 136, and tailpipe or stack 37. Aftertreatment system 136 may include NOx and temperature sensor 38; a first hydrocarbon source 140a; a second hydrocarbon source 140b; a first oxidation catalyst 142a; a second oxidation catalyst 142b; particulate filter 44; ammonia source 46; selective catalytic reduction device (SCR) 48; and ammonia oxidation catalyst 50.

The various elements of exhaust system 116 may be positioned along an exhaust flow path 129, which extends downstream from exhaust manifold 20 to atmospheric vent 37. Low-pressure turbine 32 may be positioned along exhaust flow path 129 between exhaust manifold 20 and tailpipe 37. High-pressure turbine 30 may be located along exhaust flow path 129 between exhaust manifold 20 and low-pressure turbine 32. HPT bypass valve 34 may be positioned in a bypass path extending from upstream of high-pressure turbine 30 to a location along exhaust flow path 129 upstream of low-pressure turbine 32 and downstream of high-pressure turbine 30. Aftertreatment system 136 may be located along exhaust flow path 129 between low-pressure turbine 32 and tailpipe or stack 37.

Within aftertreatment system 136, first oxidation catalyst 142a, SCR device 48, ammonia oxidation catalyst 50, second oxidation catalyst 142b, and particulate filter 44 are positioned along exhaust flow path 129. First hydrocarbon source 140a connects to exhaust flow path 129 in a location downstream of low-pressure turbine 32 and upstream from first oxidation catalyst 142a. Hydrocarbon source 140a may include a supply of hydrocarbon fluid, such as fuel, and a flow control valve (not shown) to control the amount of fuel delivered to exhaust flow path 129. First hydrocarbon source 140a may be an engine-managed late post injection, an external hydrocarbon doser, or a synthesis gas generator. The hydrocarbon fluid from hydrocarbon source 140a reacts with carbon monoxide from engine 110 in oxidation catalyst 142a to form carbon dioxide and water. By controlling the amount of hydrocarbon fluid delivered into exhaust flow path 129, the amount of carbon monoxide emitted from atmospheric vent 37 can be effectively controlled. Ammonia source 46 connects to exhaust flow path 129 in a location between first oxidation catalyst 142a and SCR 48. Ammonia source 46 may be a urea doser or a gaseous NH3 generator and may include a flow control valve to vary the amount of fluid supplied by ammonia source 46 into exhaust flow path 129. The fluid provided by ammonia source 46 reacts with NOx from engine 110 to form nitrogen and water. By controlling the amount of fluid supplied by ammonia source 46, NOx emitted from atmospheric vent 37 can be effectively controlled. Second hydrocarbon source 140b may connect to exhaust flow path 129 in a location between ammonia oxidation catalyst 50 and second oxidation catalyst 142b. Hydrocarbon source 140a may include a supply of hydrocarbon fluid, such as fuel, and a flow control valve (not shown) to control the amount of fuel delivered to exhaust flow path 129. Second hydrocarbon source 140b may be an external hydrocarbon doser, a synthesis gas generator or an extension of first hydrocarbon source 140a. The hydrocarbon fluid from hydrocarbon source 140b reacts with carbon monoxide from engine 110 in oxidation catalyst 142b to form carbon dioxide and water. By controlling the amount of hydrocarbon fluid delivered into exhaust flow path 129, the amount of carbon monoxide emitted from atmospheric vent 37 can be effectively controlled.

Air flows from intake source 22 downstream into low-pressure compressor 24, which is part of a low-pressure turbocharger 52 and which is driven by turbine 32 of low-pressure turbocharger 52. The action of low-pressure compressor 24 forces air downstream to high-pressure compressor 26, which is part of a high-pressure turbocharger 54 and which is driven by high-pressure turbine 30. HPC bypass valve 28 is in a position to provide all airflow from low-pressure compressor 24 to high-pressure compressor 26, meaning that the bypass path is closed. In the event high-pressure compressor 26 is incapable of compressing intake air, perhaps because exhaust flow is too high, if engine 110 requires less pressure from high-pressure compressor 26, or for other operational reasons, HPC bypass valve 28 may direct some or all airflow from low-pressure compressor 24 directly to intake manifold 18.

After combustion in engine body 12, exhaust gas exits engine body 12 by way of exhaust manifold 20, entering exhaust flow path 129 of exhaust system 116. The exhaust gas may flow downstream to high-pressure turbine 30, causing rotation of high-pressure turbine 30, which then drives high-pressure compressor 26, previously described. Exhaust gas then flows to low-pressure turbine 32, causing rotation of low-pressure turbine 32, which drives low-pressure compressor 24, previously described. The exhaust gas follows this flow path because HPT bypass valve 34 is normally closed, blocking exhaust gas flow through the bypass path. If exhaust flow is too high to drive high-pressure turbine 30 or if there are other reasons to bypass high-pressure turbine 30, HPT bypass valve 34 may direct some or all exhaust gas flow around high-pressure turbine 30 directly to low-pressure turbine 32. Flowing downstream from low-pressure turbine 32, the exhaust gases enter aftertreatment system 136. Signals from temperature and pressure sensor 38 provide information to engine 110 that assists engine 110 in determining the timing and amount of hydrocarbons that hydrocarbon source 140a and hydrocarbon source 140b should introduce into exhaust flow path 29 and the timing and amount of ammonia that ammonia source 46 should introduce into exhaust flow path 129. Engine 110 may use information from other sensors and systems (not shown) to assist in the determination of when and how much hydrocarbons and ammonia need to be introduced into flow path 129. Exhaust gas flows into first oxidation catalyst 142a, which converts hydrocarbons and carbon monoxide from engine 110 into water and carbon dioxide. As exhaust gas flows toward SCR 48, ammonia may be introduced into the exhaust gas flow by ammonia source 46. SCR 48 uses the ammonia to convert NOx into nitrogen and water. Because of the possibility of ammonia slip into the exhaust gas flow or stream, ammonia oxidation catalyst 50 may be located downstream from SCR 48. Catalyst 50 acts to convert ammonia to nitrogen and water. The exhaust gas then flows toward a second oxidation catalyst 142b. Before entering second oxidation catalyst 142b, hydrocarbons from second hydrocarbon source 140b may be introduced into exhaust flow path 129. Second oxidation catalyst 142b converts hydrocarbons and carbon monoxide from engine 110 into water and carbon dioxide. Exhaust gas then enters particulate filter 44, which removes soot and other particulates from the exhaust gas flow. The exhaust gas may then flow to an atmospheric outlet 37, which may be a tailpipe, stack or other device.

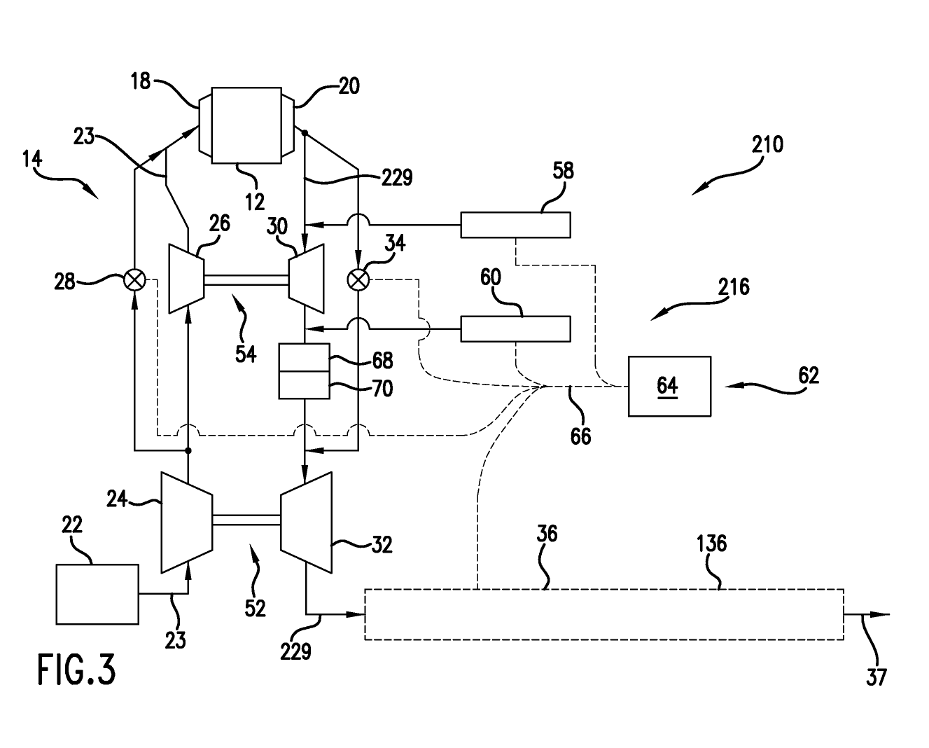

Referring now to FIG. 3, a first exemplary embodiment of the present disclosure is shown. Elements shown in this embodiment and having the same number as elements in previously described figures operate as previously described. These elements are described in this embodiment only for the sake of clarity.

An internal combustion engine 210 includes engine body or block 12, intake system 14, an exhaust system 216 and a control system 62. Intake system 14 is as described in the previous embodiment. Exhaust system 216 may include high-pressure turbine 30; low-pressure turbine 32; high-pressure turbine (HPT) bypass valve 34; aftertreatment system 36 or aftertreatment system 136 or another suitable aftertreatment system; and tailpipe or stack 37. Exhaust system 216 may also include a high-pressure hydrocarbon source 58, a low-pressure hydrocarbon source 60, an inter-stage oxidation catalyst 68, and an inter-stage passive NOx adsorber 70. High-pressure hydrocarbon source 58 may be an engine-managed late post injection, external hydrocarbon doser, or a synthesis gas generator. Low-pressure hydrocarbon source 60 may be an external hydrocarbon doser or a synthesis gas generator. The hydrocarbon fluid from hydrocarbon source 58 and from hydrocarbon source 60 reacts with carbon monoxide from engine 210 in oxidation catalyst 68 to form carbon dioxide and water. By controlling the amount of hydrocarbon fluid delivered into exhaust flow path 229, the amount of carbon monoxide emitted from atmospheric vent 37 can be effectively controlled.

The various elements of exhaust system 216 may be positioned along an exhaust flow path 229, which extends downstream from exhaust manifold 20 to atmospheric vent 37. Low-pressure turbine 32 may be positioned along exhaust flow path 229 between exhaust manifold 20 and tailpipe 37. High-pressure turbine 30 may be located along exhaust flow path 229 between exhaust manifold 20 and tailpipe 37. HPT bypass valve 34 may be positioned in a bypass path extending from upstream of high-pressure turbine 30 to a location along exhaust flow path 29 upstream of low-pressure turbine 32 and downstream of high-pressure turbine 30. Either aftertreatment system 36 or aftertreatment system 136 may be located along exhaust flow path 229 between low-pressure turbine 32 and tailpipe or stack 37.

In the exemplary embodiment, high-pressure hydrocarbon source 58 is connected to exhaust gas flow path 229 between high-pressure turbine 30 and exhaust manifold 20. Low-pressure hydrocarbon source 60 is connected to exhaust gas flow path 229 between high-pressure turbine 30 and low-pressure turbine 32. Inter-stage oxidation catalyst 68 is located along flow path 229 downstream from high-pressure turbine 30 and downstream of the connection of low-pressure hydrocarbon source 60, yet upstream from low-pressure turbine 32. Inter-stage passive NOx adsorber 70 may be positioned along flow path 229 downstream from inter-stage oxidation catalyst 68. The bypass path connects to exhaust gas flow path 229 downstream of NOx adsorber 70.

Control system 62 may include a control module 64 and a wiring harness 66. Control module 64 may be an electronic control unit or electronic control module (ECM) that monitors the performance of engine 210 or may monitor other vehicle conditions. Control module 64 may be a single processor, a distributed processor, an electronic equivalent of a processor, or any combination of the aforementioned elements, as well as software, electronic storage, fixed lookup tables and the like. Control module 64 may connect to certain components of engine 210 by wire harness 66, though such connection may be by other means, including a wireless system. Control module 64 may be a digital or analog circuit.

Control system 62 may connect to HPC bypass valve 28, HPT bypass valve 34, high-pressure hydrocarbon source 58, low-pressure hydrocarbon source 60, and various elements of the aftertreatment system, such as aftertreatment system 36 or aftertreatment system 136, including NOx and temperature sensor 38.

Air flows from intake source 22 downstream into low-pressure compressor 24, which is part of low-pressure turbocharger 52 and which is driven by turbine 32 of low-pressure turbocharger 52. The action of low-pressure compressor 24 forces air downstream to high-pressure compressor 26, which is part of high-pressure turbocharger 54 and which is driven by high-pressure turbine 30. HPC bypass valve 28 is in a position to provide all airflow from low-pressure compressor 24 to high-pressure compressor 26, meaning that the bypass path is closed. In the event high-pressure compressor 26 is incapable of compressing intake air, perhaps because exhaust flow is too high, if engine 210 requires less pressure from high-pressure compressor 26, or for other operational reasons, HPC bypass valve 28 may direct some or all airflow from low-pressure compressor 24 directly to intake manifold 18.

After combustion in engine body 12, exhaust gas exits engine body 12 by way of exhaust manifold 20, entering exhaust flow path 229 of exhaust system 216. The exhaust gas may then flow downstream to high-pressure turbine 30, causing rotation of high-pressure turbine 30, which then drives high-pressure compressor 26, previously described. Aftertreatment system 36 and aftertreatment system 136 require a minimum temperature to properly convert NOx and hydrocarbons to carbon monoxide and water. Once engine 210 is fully warmed up, the temperature of exhaust gas flowing through exhaust flow path 229 is sufficient to enable the function of, for example, diesel oxidation catalysts 42, 142a and 142b. If the temperature of the aftertreatment system, for example aftertreatment system 36 or aftertreatment system 136, is insufficient for NOx conversion, such as may occur during cold start of engine 210 and which may be indicated by a signal to control module 64 from NOx and temperature sensor 38, then control module 64 may send a control signal to high-pressure hydrocarbon source 58 to release hydrocarbons into exhaust flow path 229. Control module 64 may also send a signal to low-pressure hydrocarbon source 60 to release hydrocarbons into exhaust path 229, if low-pressure hydrocarbon source 60 exists. Conversely, control module 64 may send a control signal to low-pressure hydrocarbon source 60 without sending a signal to high-pressure hydrocarbon source 58. The needs of internal combustion engine 210 may require the addition or varying of fluid from only one of high-pressure hydrocarbon source 58 and low-pressure hydrocarbon source 60, which is why the signal may go to one, the other, or both sources.

Exhaust gas then flows to inter-stage oxidation catalyst 68, where the hydrocarbons and carbon monoxide are converted into water and carbon dioxide. As the exhaust gas flow passes through inter-stage passive NOx adsorber 70, adsorber 70 is capable of adsorbing all NOx received from exhaust manifold 20 up to the adsorption capacity of adsorber 70.

The temperature required for adsorber 70 to function is substantially lower than that required for selective catalytic reduction, such as occurs in previously described SCR 48. However, during light load cold start operation, the temperature of adsorber 70 may be insufficient for adsorber 70 to work properly. In this situation, a command/control signal to only one of high-pressure hydrocarbon source 58 or low-pressure hydrocarbon source 60, or a command/control signal to both high-pressure hydrocarbon source 58 and to low-pressure hydrocarbon source 60, may be used to dose hydrogen, carbon monoxide or hydrocarbons upstream of inter-stage oxidation catalyst 68. Oxidation of hydrocarbons across oxidation catalyst 68 provides an increase in the temperature of the exhaust gas flow to warm or heat inter-stage passive NOx adsorber 70 to a temperature at or above a minimum temperature for effective operation. Oxidation catalyst 68 may be at the hydrocarbon light-off temperature based on exhaust gas temperature at the outlet of high-pressure turbine 30, which can be further controlled by engine operation at light-load conditions.

As engine 210 transitions from light load to medium or high load, ECU 64 signals to HPT bypass valve 34, which, as previously described, is normally closed, to open gradually to bypass some exhaust gas flow around high-pressure turbine 30, inter-stage oxidation catalyst 68 and inter-stage adsorber 70. At this point, the exhaust mass flow and temperature are sufficient to enable functioning of downstream SCR 48, which means that inter-stage oxidation catalyst 68 and inter-stage adsorber 70 are no longer necessary.

Though HPT bypass valve 34 is open, some exhaust gas always flows through high-pressure turbine 30. ECU or control module 64 has received a temperature signal, such as a signal from sensor 38, that the temperature of the exhaust gas is within the operating temperature range of the components of the aftertreatment system, such as aftertreatment system 36 and aftertreatment system 136. The same temperature that permits operation of, for example, oxidation catalysts 42, 142a and 142b and SCR 48, is sufficient to cause desorption of NOx from inter-stage adsorber 70. Thus, the high temperature exhaust gas flow through high-pressure turbine 30, inter-stage oxidation catalyst 68, and inter-stage adsorber 70 during high load operation is responsible for NOx desorption from adsorber 70, making NOx storage available for a subsequent cold start cycle. In some cases, additional thermal management, assisted by high-pressure hydrocarbon source 58 or low-pressure hydrocarbon source 60, or by both high-pressure hydrocarbon source 58 and low-pressure hydrocarbon source 60, may be necessary to desorb NOx stored on inter-stage adsorber 70. The formulation of adsorber 70 may be such that its NOx desorption temperature is slightly higher than the activation temperature of SCR48; thus, NOx desorption in adsorber 70 may correspond with selective catalytic reduction in SCR 48. Exhaust gas flow during the adsorption and desorption phases should be lean since a rich mixture may cause conversion of NOx, depending on the catalysis temperature and formulation of inter-stage adsorber 70.

As with the conventional engine previously described, exhaust gas flows downstream from HPT bypass valve 34 or inter-stage adsorber 70 to low-pressure turbine 32, causing rotation of low-pressure turbine 32, which drives low-pressure compressor 24. Flowing downstream from low-pressure turbine 32, the exhaust gases enter an aftertreatment system, which may be aftertreatment system 36, aftertreatment system 136, or another suitable aftertreatment system.

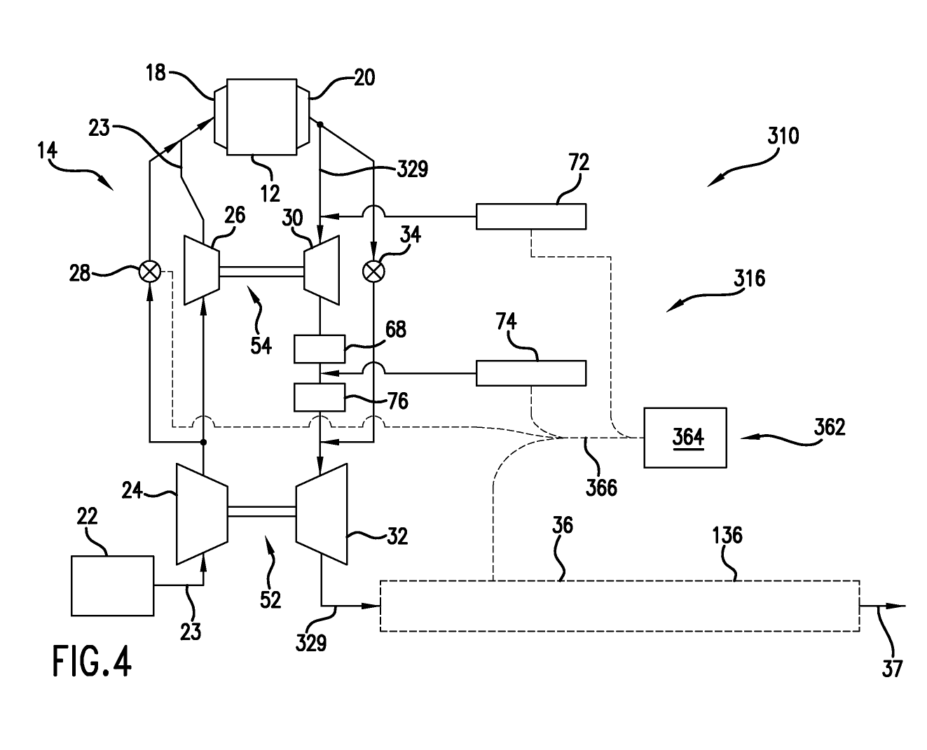

Referring now to FIG. 4, a second exemplary embodiment of the present disclosure is shown. Elements shown in this embodiment and having the same number as elements in previously described figures operate as previously described. These elements are described in this embodiment only for the sake of clarity.

An internal combustion engine 310 includes engine body or block 12, intake system 14, an exhaust system 316, and a control system 362. Intake system 14 is as described in the previous embodiment. Exhaust system 316 may include high-pressure turbine 30, low-pressure turbine 32, high-pressure turbine (HPT) bypass valve 34, aftertreatment system 36 or aftertreatment system 136 or another suitable aftertreatment system, and tailpipe or stack 37. Exhaust system 316 may also include a high-pressure ammonia source 72, a low-pressure ammonia source 74, inter-stage oxidation catalyst 68, and an inter-stage selective catalytic reduction device (SCR) 76. High-pressure ammonia source 72 may be a urea doser or a gaseous NH3 generator. Low-pressure ammonia source 74 may be a gaseous NH3 generator or a urea doser. High-pressure ammonia source 72 and low-pressure ammonia source 74 may include flow control valves to vary the amount of fluid supplied by ammonia source 72 and ammonia source 74 into an exhaust flow path 329. The fluid provided by ammonia source 72 and ammonia source 74 reacts with NOx from engine 310 to form nitrogen and water. By controlling the amount of fluid supplied by ammonia source 46, NOx emitted from atmospheric vent 37 can be effectively controlled during cold start operation of engine 310.

The various elements of exhaust system 316 may be positioned along exhaust flow path 329, which extends downstream from exhaust manifold 20 to atmospheric vent 37. Low-pressure turbine 32 may be positioned along exhaust flow path 329 between exhaust manifold 20 and tailpipe 37. High-pressure turbine 30 may be located along exhaust flow path 329 between exhaust manifold 20 and low-pressure turbine 32. HPT bypass valve 34 may provide a bypass path from exhaust manifold 20 to a location along exhaust flow path 329 upstream of low-pressure turbine 32. Either aftertreatment system 36 or aftertreatment system 136 may be located along exhaust flow path 329 between low-pressure turbine 32 and tailpipe or stack 37.

High-pressure ammonia source 72 is connected to exhaust gas flow path 329 between high-pressure turbine 30 and exhaust manifold 20. Low-pressure ammonia source 74 is connected to exhaust gas flow path 329 between high-pressure turbine 30 and low-pressure turbine 32. Inter-stage oxidation catalyst 68 is located along flow path 329 downstream from high-pressure turbine 30. Inter-stage SCR 76 is positioned downstream from inter-stage oxidation catalyst 68 and upstream from low-pressure turbine 32.

Control system 362 may include a control module 364 and a wiring harness 366. Control module 364 may be an electronic control unit or electronic control module (ECM) that monitors the performance of engine 310 or may monitor other vehicle conditions. Control module 364 may be a single processor, a distributed processor, an electronic equivalent of a processor, or any combination of the aforementioned elements, as well as software, electronic storage, fixed lookup tables and the like. Control module 364 may connect to certain components of engine 310 by wire harness 366, though such connection may be by other means, including a wireless system. Control module 364 may be a digital or analog circuit.

Control system 316 may connect to HPC bypass valve 28, HPT bypass valve 34, high-pressure ammonia source 72, low-pressure ammonia source 74, and various elements of the aftertreatment system, such as aftertreatment system 36 or aftertreatment system 136, including NOx and temperature sensor 38.

Air flows from intake source 22 downstream into low-pressure compressor 24, which is part of a low-pressure turbocharger 52 and which is driven by turbine 32 of low-pressure turbocharger 52. The action of low-pressure compressor 24 forces air downstream to high-pressure compressor 26, which is part of a high-pressure turbocharger 54 and which is driven by high-pressure turbine 30. HPC bypass valve 28 is in a position to provide all airflow from low-pressure compressor 24 to high-pressure compressor 26, meaning that the bypass path is closed. In the event high-pressure compressor 26 is incapable of compressing intake air, perhaps because exhaust flow is too high, if engine 310 requires less pressure from high-pressure compressor 26, or for other operational reasons, HPC bypass valve 28 may direct some or all airflow from low-pressure compressor 24 directly to intake manifold 18.

After combustion in engine body 12, exhaust gas exits engine body 12 by way of exhaust manifold 20, entering exhaust flow path 329 of exhaust system 316. The exhaust gas may then flow downstream to high-pressure turbine 30, causing rotation of high-pressure turbine 30, which then drives high-pressure compressor 26, previously described.

If the temperature of the aftertreatment system is insufficient for NOx conversion, such as may occur during cold start operation and which may be determined by control module 364 based on a sensed signal from NOx and temperature sensor 38, then control module 364 may send a control signal to high-pressure ammonia source 72 to release ammonia into exhaust flow path 329. Control module 364 may also send a signal to low-pressure ammonia source 74 to release ammonia into exhaust path 329, if low-pressure ammonia source 74 exists. Conversely, control module 364 may send a control signal to low-pressure ammonia source 74 without sending a signal to high-pressure ammonia source 72. The needs of internal combustion engine 310 may only require one of high-pressure ammonia source 72 and low-pressure ammonia source 74, which is why the signal may go to one, the other, or both.

Exhaust gas then flows downstream from high-pressure turbine 30 to inter-stage oxidation catalyst 68, where hydrocarbons present in the exhaust gas and carbon monoxide are converted into water and carbon dioxide. The exhaust gas then flows to inter-stage SCR 76. The proximity of inter-stage SCR 76 to exhaust manifold 20 permits inter-stage SCR 76 to warm up to an operational condition faster than an SCR in an aftertreatment system, such as SCR 48 in either aftertreatment system 36 or aftertreatment system 136. That is, SCR 76 is positioned along exhaust path 329 a relatively short distance along the exhaust flow path from manifold 20, in comparison to conventional systems. In this regard, SCR 76 is positioned between high-pressure turbine 30 and low-pressure turbine 32, a substantial distance upstream from a downstream exhaust aftertreatment system, such as aftertreatment system 36 or 136.

There may be a variety of techniques employed to rapidly warm inter-stage SCR 76. As noted above, the proximity to exhaust manifold 20 and the temperature of exhaust gas existing high-pressure turbine 30 may be sufficient to warm inter-stage SCR 76 to an operating temperature. High-pressure turbine 30 may be operated inefficiently intentionally to increase temperature transfer to inter-stage SCR 76, which would also increase the temperature of inter-stage oxidation catalyst 68. Inefficient operation of high-pressure turbine 30 may be accomplished by opening high-pressure turbine bypass valve 34. Another way to increase the temperature of inter-stage SCR 76 is to increase the temperature of the exhaust gas in engine body 12 by opening the exhaust valves (not shown) early. Yet another technique may involve bypassing an EGR cooler (not shown) or a charge-air cooler (CAC) (not shown) to increase the temperature of the exhaust gas.

As the exhaust gas flows through inter-stage SCR 76, inter-stage SCR 76 uses the ammonia from high-pressure ammonia source 72, low-pressure ammonia source 74, or both, to convert NOx into nitrogen and water. Any ammonia slip from inter-stage SCR 76 is accommodated within the subsequent aftertreatment system.

As engine 310 transitions from light load to medium or high load, HPT bypass valve 34, which, as described hereinabove, is normally open, gradually opens to bypass some exhaust gas flow around high-pressure turbine 30, inter-stage oxidation catalyst 68 and inter-stage SCR 76. At this point, the exhaust mass flow and temperature are sufficient to enable functioning of downstream SCR 48, which means that inter-stage oxidation catalyst 68 and inter-stage SCR 76 are no longer necessary.

One advantage to the configuration of FIG. 4 is that additional thermal management may be unnecessary since SCR 76 does not need to be regenerated or desorbed for future functioning. Since additional thermal management is unnecessary, the configuration of FIG. 4 should result in an improved fuel economy over approaches requiring the addition of hydrocarbons for thermal management. The location of SCR 76 with respect to exhaust manifold 20 also enables a fuel economy improvement as compared to oxidation of late-post injection at an oxidation catalyst downstream of low-pressure turbine 32 for warm up of SCR 48 in aftertreatment system 36, aftertreatment system 136, or another suitable aftertreatment system.

As with the conventional engines previously described, exhaust gas flows downstream from either HPT bypass valve 34 or inter-stage SCR 76 to low-pressure turbine 32, causing rotation of low-pressure turbine 32, which drives low-pressure compressor 24. Flowing downstream from low-pressure turbine 32, the exhaust gas enters an aftertreatment system, which may be aftertreatment system 36, aftertreatment system 136, or another suitable aftertreatment system.

The systems described in FIGS. 3 and 4 enable higher NOx conversion efficiency during cold start operation, reducing emissions from exhaust vent 37. The reduced emissions also decrease fuel use that would otherwise be required to reduce NOx emissions, thus indirectly improving fuel economy.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

I/we claim:

1. An internal combustion engine, comprising:
an engine body;
an aftertreatment system;
an exhaust flow path extending from the engine body to the aftertreatment system;
a high-pressure turbine positioned along the exhaust flow path between the engine body and the aftertreatment system;
a low-pressure turbine positioned along the exhaust flow path between the high-pressure turbine and the aftertreatment system;
an oxidation catalyst positioned along the exhaust flow path between the high-pressure turbine and the low-pressure turbine; and
a selective catalytic reduction device positioned along the exhaust flow path between the oxidation catalyst and the low-pressure turbine.

2. The internal combustion engine of claim 1, further including an ammonia source connected to the exhaust flow path between the engine body and the high-pressure turbine.

3. The internal combustion engine of claim 2, further including a temperature sensor positioned along the exhaust flow path and adapted to transmit a signal, and a control module adapted to receive the signal and operable to generate a control signal for the ammonia source based at least partially on the signal received from the temperature sensor.

4. The internal combustion engine of claim 1, further including an ammonia source connected to the exhaust flow path between the oxidation catalyst and the selective catalytic reduction device.

5. The internal combustion engine of claim 4, further including a temperature sensor positioned along the exhaust flow path and adapted to transmit a signal, and a control module adapted to receive the signal and operable to generate a control signal for the ammonia source based at least partially on the signal received from the temperature sensor.

6. The internal combustion engine of claim 1, further including a first ammonia source connected to the exhaust flow path between the engine body and the high-pressure turbine and a second ammonia source connected to the exhaust flow path between the oxidation catalyst and the selective catalytic reduction device.

7. The internal combustion engine of claim 6, further including a temperature sensor positioned along the exhaust flow path and adapted to transmit a signal and a control module adapted to receive the signal and operable to generate a control signal for the first ammonia source and the second ammonia source based at least partially on the signal received from the temperature sensor.

8. The internal combustion engine of claim 1, further including a bypass valve connected to the exhaust manifold and to the exhaust flow path in a location between the selective catalytic reduction device and the low-pressure turbine.

9. The internal combustion engine of claim 8, further including a temperature and NOx sensor located along the exhaust flow path and a control module adapted to receive a signal from the temperature and NOx sensor and operable to send a control signal to the bypass valve based at least partially on the signal from the temperature and NOx sensor.

10. The internal combustion engine of claim 1, the aftertreatment system including an oxidation catalyst.

11. The internal combustion engine of claim 10, the aftertreatment system including an SCR device positioned along the exhaust flow path downstream from the oxidation catalyst and an ammonia source positioned between the oxidation catalyst and the SCR device.

12. An internal combustion engine, comprising:
an engine body;
an aftertreatment system;
an exhaust flow path extending from the engine body to the aftertreatment system;
a high-pressure turbine positioned along the exhaust flow path between the engine body and the aftertreatment system;
a low-pressure turbine positioned along the exhaust flow path between the high-pressure turbine and the aftertreatment system;
an oxidation catalyst positioned along the exhaust flow path between the high-pressure turbine and the low-pressure turbine; and
a passive NOx adsorber positioned along the exhaust flow path between the oxidation catalyst and the low-pressure turbine.

13. The internal combustion engine of claim 12, further including a hydrocarbon source connected to the exhaust flow path between the engine body and the high-pressure turbine.

14. The internal combustion engine of claim 13, further including a temperature sensor positioned along the exhaust flow path and adapted to transmit a signal, and a control module adapted to receive the signal and operable to generate a control signal for the hydrocarbon source based at least partially on the signal received from the temperature sensor.

15. The internal combustion engine of claim 12, further including a hydrocarbon source connected to the exhaust flow path between the high-pressure turbine and the oxidation catalyst.

16. The internal combustion engine of claim 15, further including a temperature sensor positioned along the exhaust flow path and adapted to transmit a signal, and a control module adapted to receive the signal and operable to generate a control signal for the hydrocarbon source based at least partially on the signal received from the temperature sensor.

17. The internal combustion engine of claim 12, further including a first hydrocarbon source connected to the exhaust flow path between the engine body and the high-pressure turbine and a second hydrocarbon source connected to the exhaust flow path between the high-pressure turbine and the oxidation catalyst.

18. The internal combustion engine of claim 17, further including a temperature sensor positioned along the exhaust flow path and adapted to transmit a signal, and a control module adapted to receive the signal and operable to generate a control signal for the first hydrocarbon source and the second hydrocarbon source based at least partially on the signal received from the temperature sensor.

19. The internal combustion engine of claim 12, further including a bypass valve connected to the exhaust manifold and to the exhaust flow path in a location between the selective catalytic reduction device and the low-pressure turbine.

20. The internal combustion engine of claim 19, further including a temperature and NOx sensor located along the exhaust flow path, and a control module adapted to receive a signal from the temperature and NOx sensor and operable to send a control signal to the bypass valve based at least partially on the signal from the temperature and NOx sensor.

21. A method of controlling emissions from an internal combustion engine during cold start operation, the method comprising:
providing an exhaust gas flow path from an internal combustion engine through a first turbine, a second turbine, and a downstream aftertreatment system having a first operating temperature;
positioning at least one emission reducing device, having a second operating temperature lower than the first operating temperature, between the first turbine and the second turbine, the at least one emission reducing device operable to react a fluid with emissions from the internal combustion engine to reduce the volume of the emissions;
providing the fluid to the exhaust gas flow path between the internal combustion engine and the at least one emission reducing device; and
providing a bypass path from the internal combustion engine to the exhaust gas flow path at a location between the second turbine and the at least one emission reducing device and engaging the bypass path when the temperature in the exhaust gas flow path reaches the first operating temperature.

22. The method of claim 21, wherein the at least one emission reducing device is a NOx adsorber and the fluid is a hydrocarbon.

23. The method of claim 21, wherein the at least one emission reducing device is an SCR device and the fluid is ammonia.
